(19) United States
(12) Patent Application Publication
(10) Pub. No.: US 2008/0313323 A1
(43) Pub. Date: Dec. 18, 2008

(54) Methods, Systems, And Computer Program Products For Monitoring Transaction Status With A Presence Tuple

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/763,817

(22) Filed: Jun. 15, 2007

(51) Int. Cl. G06F 15/173; G06F 17/30

(52) U.S. Cl. 709/224; 707/202; 707/E17.007

(57) ABSTRACT

Methods and systems are described for monitoring transaction status with a presence tuple. A transaction having a multi-stage life-cycle and having a transaction participant is detected. A presentity is provided for tracking a status associated with a stage of the life-cycle and for publishing the status to a presence tuple associated with the presentity in response to the detection of a transition of the life-cycle to the stage. A subscription to the presence tuple is established for the transaction participant based on information determined from the transaction. At a presence server, a message is received including presence status associated with a stage of a transaction and transaction participant information. The presence information is processed for creating a presence tuple for tracking the transaction. A subscription to the presence tuple is established for the transaction participant based on the transaction participant information received in association with the message.

### BACKGROUND

People and devices are relatively permanent. The need to keep up with the status, activity, availability, location, and communicate with these relatively permanent entities has received a lot of attention. Network monitoring systems, methods, and protocols, such as simple network management protocol (SNMP), have been used to monitor networks and attached devices. Keeping up with other people is an activity humans have been engaged in for thousands of years. In recent years, presence systems have emerged and are used primarily to track the availability of people for communications as well as to track devices and services, such as web servers.

Most activities that people and devices engage in are short-term in nature and are typically not tracked while ongoing. At best, outcomes are reported and events may be logged while an activity is ongoing. Logs are typically used after a short-term activity has ended. Some activities, such as package shipments, are trackable, but the process is time consuming. A consumer typically receives an email with a tracking number. The user must repeatedly visit the shipper's website and reenter the tracking number to track a package. An option to receive email updates is also available, but email delivery is not real-time and requires a user to open and read the email message.

Accordingly, there exists a need for methods, systems, and computer program products for monitoring transaction status with a presence tuple.

### SUMMARY

Methods and systems are described for monitoring transaction status with a presence tuple. In one aspect, a transaction having a multi-stage life-cycle and having a transaction participant is detected, wherein the transaction is initiated in response to a message received via a network. A presentity is provided for tracking a status associated with a stage of the life-cycle and for publishing the status to a presence tuple associated with the presentity in response to the detection of a transition of the life-cycle to the stage. A subscription to the presence tuple for the transaction participant is established based on information determined from the transaction, wherein the subscription allows for the transaction participant to receive a notification including the status associated with the stage.

In another aspect, a message including presence status associated with a stage of a transaction and transaction participant information is received, the transaction having a multi-stage life-cycle and initiated in response to a message received via a network. The presence information is processed for creating a presence tuple for tracking the transaction. A subscription to the presence tuple for the transaction participant is established based on the transaction participant information received in association with the message, wherein the subscription allows for the transaction participant to receive a notification including the status associated with the stage.

In another aspect, a system for monitoring transaction status with a presence tuple includes: means for detecting a transaction having a multi-stage life-cycle and having a transaction participant, wherein the transaction is initiated in response to a message received via a network; means for providing a presentity for tracking a status associated with a stage of the life-cycle and for publishing the status to a presence tuple associated with the presentity in response to the detection of a transition of the life-cycle to the stage; and means for establishing a subscription to the presence tuple for the transaction participant based on information determined from the transaction, wherein the subscription allows for the transaction participant to receive a notification including the status associated with the stage.

In another aspect, a system for monitoring transaction status with a presence tuple includes: a transaction handler component configured for detecting a transaction having a multi-stage life-cycle and having a transaction participant, wherein the transaction is initiated in response to a message received via a network; a transaction monitor component configured for providing a presentity for tracking a status associated with a stage of the life-cycle and for publishing the status to a presence tuple associated with the presentity in response to the detection of a transition of the life-cycle to the stage; and a transaction monitor component configured for establishing a subscription to the presence tuple for the transaction participant based on information determined from the transaction, wherein the subscription allows for the transaction participant to receive a notification including the status associated with the stage.

In another aspect, a system for monitoring transaction status with a presence tuple includes: means for receiving a message including presence status associated with a stage of a transaction and transaction participant information, the transaction having a multi-stage life-cycle and initiated in response to a message received via a network; means for processing the presence information for creating a presence tuple for tracking the transaction; and means for establishing a subscription to the presence tuple for the transaction participant based on the transaction participant information received in association with the message, wherein the subscription allows for the transaction participant to receive a notification including the status associated with the stage.

In another aspect, a system for monitoring transaction status with a presence tuple includes: a message router component configured for receiving a message including presence status associated with a stage of a transaction and transaction participant information, the transaction having a multi-stage life-cycle and initiated in response to a message received via a network; a publication handler component configured for processing the presence information for creating a presence tuple for tracking the transaction; and a subscription handler component configured for establishing a subscription to the presence tuple for the transaction participant based on the transaction participant information received in association with the message, wherein the subscription allows for the transaction participant to receive a notification including the status associated with the stage.

In another aspect, a computer readable medium includes a computer program, executable by a machine, for monitoring transaction status with a presence tuple. The computer program includes executable instructions for: detecting a transaction having a multi-stage life-cycle and having a transaction participant, wherein the transaction is initiated in response to a message received via a network; providing a presentity for tracking a status associated with a stage of the life-cycle and for publishing the status to a presence tuple associated with the presentity in response to the detection of a transition of the life-cycle to the stage; and establishing a subscription to the presence tuple for the transaction participant based on information determined from the transaction, wherein the subscription allows for the transaction participant to receive a notification including the status associated with the stage.

In another aspect, a computer readable medium includes a computer program, executable by a machine, for monitoring transaction status with a presence tuple. The computer program includes executable instructions for: receiving a message including presence status associated with a stage of a transaction and transaction participant information, the transaction having a multi-stage life-cycle and initiated in response to a message received via a network; processing the presence information for creating a presence tuple for tracking the transaction; and establishing a subscription to the presence tuple for the transaction participant based on the transaction participant information received in association with the message, wherein the subscription allows for the transaction participant to receive a notification including the status associated with the stage.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for monitoring transaction status with a presence tuple according to an aspect of the subject matter described herein;

FIG. 2 is block a diagram illustrating a system for monitoring transaction status with a presence tuple according to another aspect of the subject matter described herein;

FIG. 3 is block a diagram illustrating an exemplary operating environment for a system for monitoring transaction status with a presence tuple according to another aspect of the subject matter described herein;

FIG. 4 is a an exemplary message flow diagram illustrating exemplary interoperation between components of a system for monitoring transaction status with a presence tuple according to another aspect of the subject matter described herein;

FIG. 5 is a block diagram illustrating another system for monitoring transaction status with a presence tuple according to another aspect of the subject matter described herein; and

FIG. 6 is a flow diagram illustrating another method for monitoring transaction status with a presence tuple according to another aspect of the subject matter described herein.

### DETAILED DESCRIPTION

Well known presence protocols, such as eXtensible messaging and presence protocol instant messaging (XMPP-IM), session initiation protocol (SIP) for instant messaging and presence leveraging extensions (SIP SIMPLE), and rendezvous protocol (RVP), are used by presence services, and Jabber Software Foundation's pub/sub protocol as specified in Jabber Enhancement Proposal (JEP) JEP0060: Publish-Subscribe. The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al., titled “Extensible Messaging and Presence Protocol (XMPP): Instant Messaging and Presence,” each of which are published and owned by the Internet Society and incorporated here in their entirety by reference.

Generally speaking, one or more publish/subscribe (“pub/sub”) servers are used to provide pub/sub services. The function of a pub/sub server, however, can be incorporated, either in whole or in part, into other entities. For example, according to the presence service model described in RFC 2778, two distinct agents of a presence service client are defined. The first of these agents, called a “presentity” (combining the terms “presence” and “entity”), provides presence information to be stored and distributed throughout the presence service on behalf of a presence client. The second type of presence agent is referred to as a “watcher.” Watchers receive presence information from a presence service on behalf of a presence client.

The presence model of RFC 2778 describes two types of watchers, referred to as “subscribers” and “fetchers.” A subscriber requests notification from the presence service of a change in some presentity client's presence information. The presence service establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

By way of example, exemplary aspects described here can employ a presence protocol as the pub/sub communication protocol. It should be understood, however, the relevant techniques described here can be performed using any pub/sub communications protocol as defined herein. Additionally, the exemplary aspect described herein is not limited to the use of a pub/sub protocol for all communications described. Other known protocols can also be used.

According to pub/sub communication protocols, a pub/sub service stores and organizes information provided by a publisher and by a subscriber in data entities referred to as tuples. As stated above, a tuple, in its broadest sense, is a data object containing one or more elements. If a tuple contains a status element it is referred to as a presence tuple (RFC 2778) and the information stored in the status element is referred to as presence information. A pub/sub service which processes presence tuples is referred to as a presence service. In addition to containing a status element, a presence tuple can include any other content.

A tuple can represent any element used to store the published information associated with a publisher or principal. The published information may include general contact information of the publisher, such as name, telephone number, email address, postal address, an Internet protocol (IP) addresses or uniform resource locators (URLs) associated with the publisher, and the like, as well as other data or content. As used here, a tuple can also be a representation that maps field names to certain values to indicate that an entity or object (e.g., the principal) includes certain components, information, and/or perhaps has certain properties.

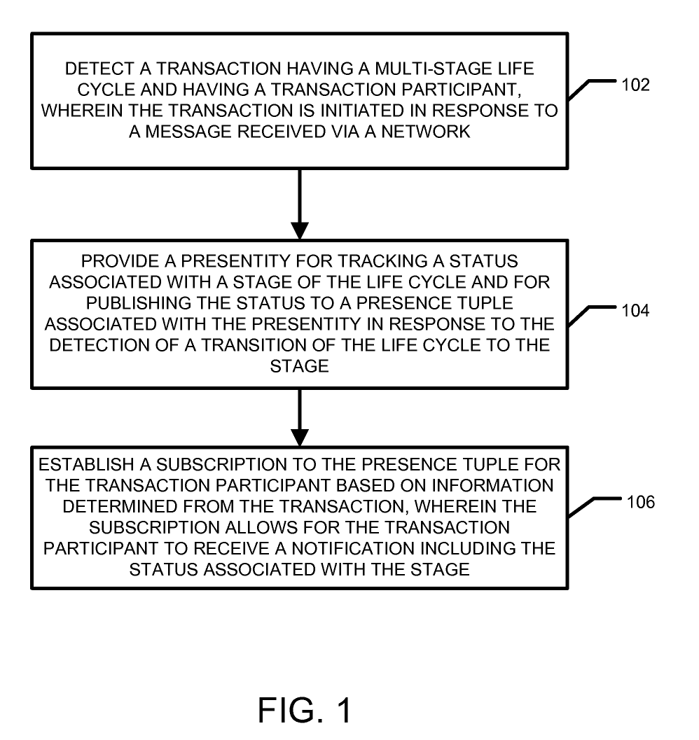

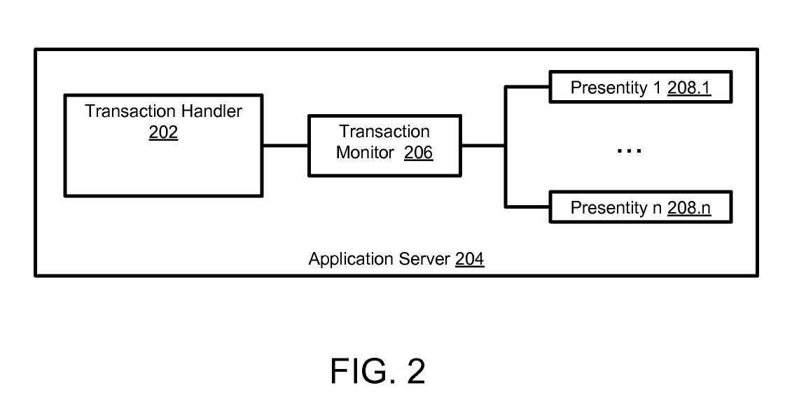

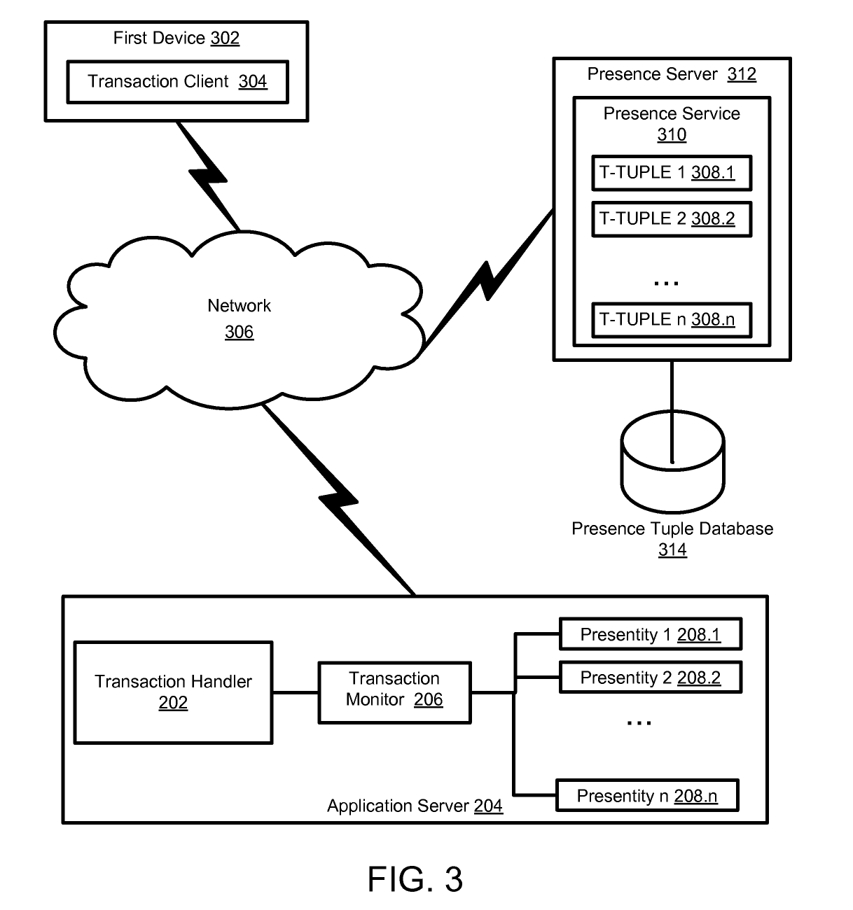

FIG. 1 is a flow diagram illustrating a method for monitoring transaction status with a presence tuple according to an exemplary aspect of the subject matter described herein. FIG. 2 is block a diagram illustrating a system for monitoring transaction status with a presence tuple according to another aspect of the subject matter described herein. FIG. 3 is block a diagram illustrating an exemplary operating environment for a system for monitoring transaction status with a presence tuple according to another aspect of the subject matter described herein. The method illustrated in FIG. 1 can be carried out by, for example, some or all of the components illustrated in FIGS. 2 and/or 3.

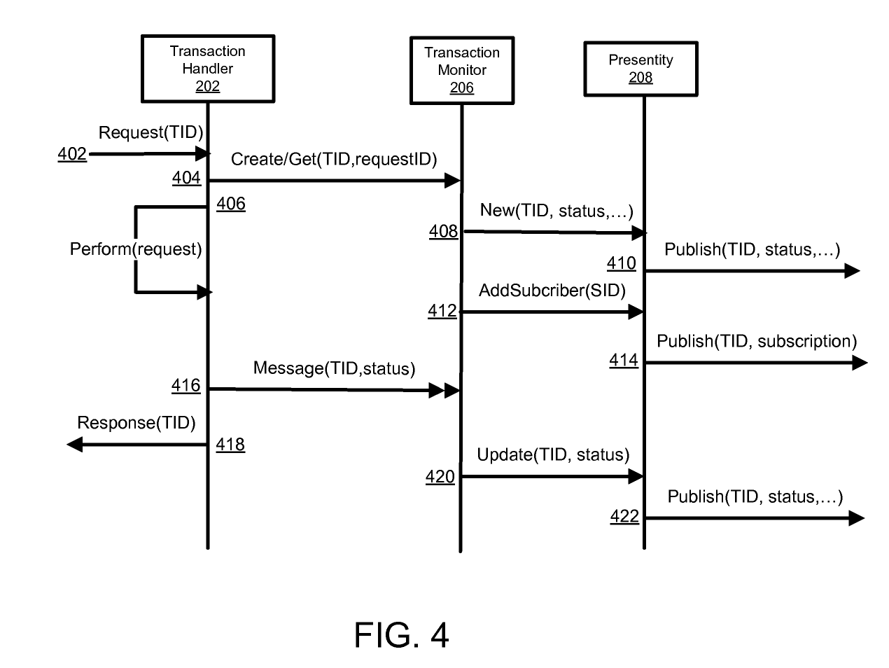

More particularly, FIG. 2 depicts an exemplary system in the form of an application server 204 and FIG. 3 depicts a network operating environment including the application server 204. FIG. 4 is an exemplary message flow diagram illustrating components of the system of FIG. 2 interoperating (e.g., within the operating environment of FIG. 3) for performing the method of FIG. 1.

Presence clients using a presence protocol for communicating with a presence server are described herein by way of example for ease of description. Other systems for providing the status of a watching entity can be configured to perform the methods described herein. Such systems are referred to as status distribution systems in this document and are considered within the scope of the methods, systems, and program products described.

With reference to FIG. 1, in block 102 a transaction having a multi-stage life-cycle and having a transaction participant is detected. The transaction is initiated in response to a message received via a network. Accordingly, a system for monitoring transaction status with a presence tuple includes means for detecting a transaction having a multi-stage life-cycle and having a transaction participant, where the transaction is initiated in response to a message received via a network. For example, as illustrated in FIG. 2, a transaction handler component 202 is configured for detecting a transaction having a multi-stage life-cycle and having a transaction participant, where the transaction is initiated in response to a message received via a network.

According to an exemplary aspect, the transaction handler component 202 operates within an execution environment provided by the application server 204. The execution environment, for example, can include a processor, processor memory, a data store such as a database, a networking subsystem, an input/output subsystem, and other hardware and software standard in application servers. In one aspect, the application server hosts a web server capable of hosting web applications accessible via hypertext transfer protocol (HTTP), internet inter-orb protocol (IIOP), simple object access protocol (SOAP), and other web protocols. The web server in some cases supports a Java 2 Enterprise Edition (J2EE) application container in which the transaction handler component 202 operates. In other cases, a .NET environment, common gateway interface (CGI), or other web server application container can be used to host the transaction handler component 202. In another aspect, the transaction handler component 202 can be a component or application of a file transfer protocol (FTP) server, an email or other messaging server, a SIP server, an instant messaging server, and/or a remote procedure call (RPC) server. A transaction handler component 202 can be a component or application of any networked service where the transaction handler component 202 performs at least a portion of the processing associated with a resource that has a multi-stage life-cycle.

A transaction can be associated with a process and/or a resource. Resources, for example, include data entities. A process associated with a transaction can be, for example, the process performed with respect to a resource over at least a portion of its life-cycle. A transaction can include another transaction. For example, a process can include a sub-process and/or a resource can include another resource as a component. Put another way, transactions can be nested.

Additional examples of processes include at least one of a shopping cart process, a purchase, a payment authorization, a delivery process, a registration process, a login process, a messaging process (e.g., delivery of an email), an upload process, a download process, a communication process, and a life-cycle of a data entity. Some of the examples herein include data entities with life-cycles. For example, authentication data associated with a login request or registration form data associated with a registration request are data associated with the life-cycles of corresponding operations based on the data. Some examples herein include both process and data resources each with life-cycles, which illustrates that transactions can include other transactions, as stated above.

Examples of a resource include a document, a file, a form, form-entered data, a communication, a session, a message, a request, and a response. While an exhaustive list of resources and/or processes associated with transactions or the various life-cycle stages associated with the resources and/or processes cannot be provided in a finite document, some examples of resources, processes, and life-cycle stages associated with the resources and processes are provided herein. For example, an online shopping cart transaction can have a multi-stage life-cycle with stages that can include non-existent, created, empty, non-empty, and/or in a state where it accepts items, have items removed, and/or updated. Various online shopping cart aspects can have more or less stages. An online purchase transaction can include stages such as, for example, accepted, approved, confirmed, partially fulfilled, shipped, payment received, and/or delivered. As with shopping cart transactions, the stages of online purchases are aspect specific. An online shopping cart transaction can include a data entity with a life-cycle in addition to a process for managing the data entity. Each can be considered to have its own life-cycle, although, typically not independent from one another. A shopping cart data entity, for example, can be created, owned, locked, saved, active, archived, and/or deleted.

Resources with relatively long life-cycles, such as human principals, devices, and service providers, are typically aware of their own state or life-cycle stage and/or play an active role in reporting their state and life-cycle stage. In contrast, human activities, device operations, instances of providing a service, and data entities often have relatively short life-cycles, are often not aware of their state, and/or, typically, don't participate in reporting their own state.

According to the subject matter described herein, the transition of a multi-stage life-cycle to a stage can be detected by monitoring a resource, detecting the receipt of a message, and/or detecting the sending of a message. For example, the transaction handler component 202 can be configured for detecting the transition of the life-cycle to the stage by monitoring a resource, detecting the receipt of a message, and/or detecting the sending of a message.

All resources can be viewed as participating in a transaction that has at least two states, non-existent and existing (also can be referred to as “new”). Although, non-existent resources are rarely tracked explicitly, they are tracked implicitly. Non-existent resources are resources for which there are no records. Although, theoretically, a transaction can exist which “lives” indefinitely, transactions generally have an end state.

In one aspect, the transaction detected by the transaction handler component 202 involves (a non-exhaustive list) a consumer, a purchaser, a seller, an auditor, a processor, a registrar, a retailer, a shipper, a support provider, a payment service, and/or a security service. In practice, a participant in a transaction (a “transaction participant”) can be any entity that plays a role in the transaction, whether it is an active or a passive role. Roles are typically transaction specific. For example, a bug fixing transaction for a software error can include roles for a detector, a reporter, a fixer, an approver, an integrator, and a tester/verifier.

The detection by the transaction handler component 202 can be performed in at least a portion of the states of a transaction. Some stages, in specific instances, may not be considered important enough to detect. The initial detection of a transaction does not have to be as a result of a transition from non-existent to created, although this is typically when most transactions are first detected.

As illustrated in FIG. 3, in addition to the application server 204 having transaction handler component 202 operating within the execution environment of the application server 204, is a first device 302 having a transaction client 304. The transaction client 304, for example, can be a Web browser that operates within the execution environment of the first device 302. The transaction client 304 is configured to send a message to the application server 204 via a network 306. The message is received by the transaction handler component 202. The message includes information that initiates a transaction or initiates further processing of an existing transaction.

For example, a user or principal associated with the first device 302 using the transaction client 304 can send an HTTP request including a GET command and a URL via the network 306 to the transaction handler component 202 of the application server 204. The GET command, in the example, initiates a session using a “cookie” and session storage maintained by a web application container and associated database. The session itself can be considered a transaction to be tracked. The transaction client 304 (e.g., a browser), issues an HTTP POST command to a URL of the application server 204 where it is detected by the transaction handler component 202 as a request to add an item to a shopping cart. The creation or state change associated with the shopping cart can be detected by the transaction handler component 202 for tracking. The transaction handler component 202 can be configured to detect a purchase, a payment process, and/or an order fulfillment process, for example.

FIG. 4 is an exemplary message flow diagram illustrating exemplary interoperation between components of a system for monitoring transaction status with a presence tuple according to another aspect of the subject matter described herein. The message 402 corresponds to a message transmitted from the transaction client 304 of the first client 302 via the network 306 to the transaction handler component 202 of the application server 204.

Returning to FIG. 1, in block 104 a presentity is provided for tracking a status associated with a stage of the life-cycle and for publishing the status to a presence tuple associated with the presentity in response to the detection of a transition of the life-cycle to the stage. Accordingly, a system for monitoring transaction status with a presence tuple includes means for providing a presentity for tracking a status associated with a stage of the life-cycle and for publishing the status to a presence tuple associated with the presentity in response to the detection of a transition of the life-cycle to the stage. For example, as illustrated in FIG. 2, a transaction monitor component 206 is configured for providing a presentity for tracking a status associated with a stage of the life-cycle and for publishing the status to a presence tuple associated with the presentity in response to the detection of a transition of the life-cycle to the stage. In example, the transaction monitor component 206 can be configured for providing a presentity for tracking a status associated with a stage corresponding to one of the transaction is new, the transaction is pending, and the transaction is complete.

For example, in an exemplary aspect, the transaction monitor component 206 detects a transaction associated with the message 402 received at the transaction handler component 202 from the transaction client 304 of the first device 302. The transition can be detected directly from the transaction handler component 202, for example, as a result of processing of the message at the transaction handler component 202. The transition can be detected indirectly via monitoring a file or database entry, for example. A transition can be detected as a result of receiving an asynchronous notification from another component involved in processing at least a portion of the transaction or may be detected in a response to a message sent by the transaction handler component 202 to another component. In some aspects, the asynchronous message or the response is received by the transaction monitor component 206 or a presentity 208 associated with the transaction.

An exemplary message is a message requesting the purchase of an item in an online shopping cart. The transaction handler component 202, in response to receiving the message 402, notifies a transaction monitor component 206 of the request. In cases where a new transaction is created, a transaction identifier can be created by the transaction handler component 202, the transaction monitor component 206, the transaction handler component 202 and the transaction monitor component 206 cooperatively, and/or a service (not shown) for creating transaction identifiers.

The transaction is processed as a principal of a presence service on behalf of the transaction principal of the first device 302 that initiated the transaction. As discussed above, a principal can report their status using an agent referred to as a presentity. For a new transaction, the transaction monitor component 206 creates a corresponding presentity 208. FIG. 2 depicts a presentity 1 208.1 for a first presentity through a presentity n 208.n for an nth presentity. Each presentity 208 is associated with a corresponding presence tuple 308. The terms “transaction tuple” and, alternatively, “t-tuple” are used in this document to refer to presence tuples having a format supporting a status for a transaction. As depicted in FIG. 3, presentity 1 208.1 publishes status for a corresponding first transaction to t-tuple 1 308.1, presentity 2 208.2 publishes status for a corresponding second transaction to t-tuple 2 308.2, and each other presentity publishes status for a corresponding transaction to a corresponding t-tuple, up through presentity n 208.n, which publishes status for an nth transaction to t-tuple n 308.n.

In FIG. 3, the t-tuples are managed by a presence service 310 operating within an execution environment provided by a presence server 312. The presence service 310 communicates with the presentities 208 via the network 306. A presence protocol or other publish/subscribe protocol can be used in a case where the presentity 208 uses a message including a publish command to request the presence service 310 to create/update the presentity's 208 corresponding t-tuple 308. Alternatively, the presence server 310 can poll a presentity 208 for determining whether the presentity's 208 corresponding t-tuple 308 requires updating.

Whenever the transaction handler component 204 and/or the transaction monitor component 206 detect a change in state of a transaction or a transition of a transaction to a state or life-cycle stage other than the transaction's current state, the presentity 208 representing the transaction is provided with the new state/stage information. The presentity 208 generates a message including a publish command, where the publish command includes the new stage of the transaction in a tuple format compatible with the t-tuple 308 format of the presence service 310. The presentity 208, using a communication subsystem of the application server 204 in the system 200 transmits the message via the network 306 to the presence service 310 via a communication subsystem of the operating environment of the presence server 312. The presence service is configured to create/update the t-tuple 308 that corresponds to the presentity 208 that transmitted the message stored in a presence tuple database 314 in FIG. 3.

A t-tuple 308 can be embodied in a variety of formats both for network transmission and for storage in the presence tuple database 314. Example 1 below depicts a presence tuple of a transaction participant. For example, the transaction participant can be the initiator of the transaction and/or the processor of the transaction. In example, if the transaction is an online purchase, the presence tuple can be associated with the service provider, such as an online retailer. A message from the transaction client 304 received by the transaction handler component 202 can initiate the purchase request and cause a transition in the life-cycle of the purchase from “non-existent” to “new” or “pending”, for example. If a purchase transaction is already in progress, the message may cause processing by the transaction handler component 202 that causes the transaction to change to another state, such as, “payment info received.”

Included in the presence tuple of the retailer are a number of t-tuples 308 in a T-TUPLES element. Each t-tuple 308 in Example 1 is represented by its own sub-tuple depicted by the T-TUPLE TYPE element. The T-TUPLE TYPE element is intended to indicate that the T-TUPLES element can take the form of a variety of transaction tuple elements each with its own format. For example, a purchase transaction can have a format including content different from a shopping cart transaction t-tuple, or a product return transaction t-tuple. All t-tuples have a format compatible with including a status element for providing a status associated with a stage of a life-cycle of the corresponding resource associated with the transaction. Thus, the t-tuples 308 included in the participant's presence tuple are also presence tuples in their own right. The depicted tuple includes an ID element that can be an identifier of the corresponding transaction, an identifier for the tuple, presentity, and/or principal, or may serve a dual role where the transaction identifier and the tuple identifier are included in the same element.

In another example employing a format similar to Example 1, a single presentity 208 can be provided that is associated with the presence tuple, for example the presence tuple of the service provider. Alternatively, each t-tuple 308 in the participant presence tuple can be provided with a corresponding presentity acting as an agent for the associated transaction. A presentity 208 corresponding to a t-tuple can operate independent of the presentity of the presence tuple or a t-tuple's presentity can be controlled by or even incorporated within the presentity of the including participant's presence tuple.

### EXAMPLE 1

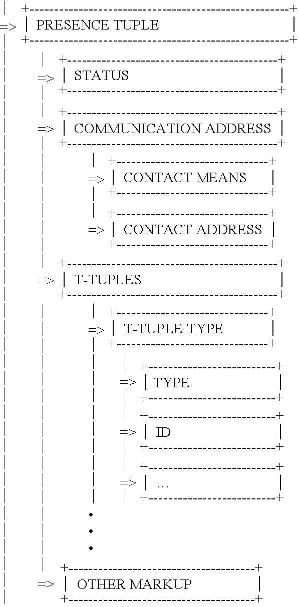

Example 2 below depicts an exemplary t-tuple 308 associated with a purchase. A PURCHASE TUPLE element is the encapsulating element of the t-tuple 308. As is required for presence tuples, a STATUS element is provided for holding status associated with a purchase transaction. In the exemplary t-tuple 308, a BUYER ID element, an ITEM TUPLE element, a PAYMENT TUPLE element, and a SHIPPING TUPLE element are depicted. The number and format of each of the named elements are exemplary. For example, a BUYER ID tuple can simply include an ID to a buyer's account record in one example while in another example it can include information relating to the buyer not stored in an account record, such as the client type used and/or a network address from which the purchase order was submitted by the buyer.

In exemplary aspects, the purchase tuple may or may not be included in another presence tuple as in Example 1. The purchase tuples may be stored in a separate table or storage region apart from other t-tuple types or all t-tuples may be stored in the same table or storage region regardless of the transaction and tuple type. A purchase tuple can include only a status element with all other transaction-related information managed by the transaction handler component 202.

### EXAMPLE 2

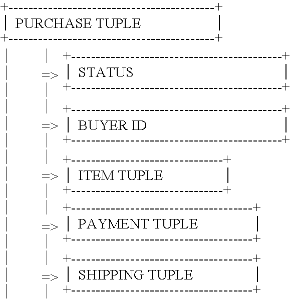

In the exemplary message flow diagram of FIG. 4, after receiving the message 402, the transaction handler component 202 sends a message 404 to the transaction monitor component 206 for monitoring a new process or retrieving information associated with an existing transaction. In the message 404, a transaction identifier “TID” may be provided as input and/or returned as a response. Upon receiving the message 404, the transaction monitor component 206 provides a presentity 208 by, for example, creating a new presentity 208 instance or allocating a free presentity 208 from a pool of instantiated presentities, as depicted by the “New” message 408. The message 408 includes an identifier associated with the transaction and a status reflecting the current stage of the life-cycle of the transaction. The presentity 208 generates a message 410 including the t-tuple information for the transaction and sends the message 410 to the presence service, e.g., to the presence server 312 over the network 306.

Returning to FIG. 1, in block 106 a subscription to the presence tuple for the transaction participant is established based on information determined from the transaction. The subscription allows for the transaction participant to receive a notification including the status associated with the stage. Accordingly, a system for monitoring transaction status with a presence tuple includes means for establishing a subscription to the presence tuple for the transaction participant based on information determined from the transaction. For example, as illustrated in FIG. 2, the transaction monitor component 206 is configured for establishing a subscription to the presence tuple for the transaction participant based on information determined from the transaction, wherein the subscription allows for the transaction participant to receive a notification including the status associated with the stage.

In one aspect, establishing a subscription to the presence tuple for the transaction participant includes identifying a watcher for the transaction participant for sending notifications to the watcher including the status associated with the stage. For example, the transaction monitor component 206 can be configured for establishing a subscription to the presence tuple for the transaction participant by identifying a watcher for the transaction participant for sending notifications to the watcher including the status associated with the stage. The watcher can be identified via one of an instant message identifier, an email address, a SIP URL, an XMPP URL, and an identifier of a presence tuple of the transaction participant, as describe by example below.

With reference to FIG. 2, the transaction monitor component 206 can receive participant information from the transaction handler component 204 for at least one participant. For example, in the case of an online purchase, the participant can be a purchaser, a receiver, a payment service, a fulfiller such as a warehouse, and/or a shipper. Each participant can be registered with the transaction handler component 202 of the application server 204. Included in the registration information of a participant that is to be subscribed to a t-tuple is watcher information allowing a presence service to locate an active watcher acting as an agent for the participant for receiving a notification associated with status update of the t-tuple and optionally other presence tuple types. For example, watcher information includes an instant message name/ID, an email address, a SIP URL, a XMPP URL, and/or an identifier of a participants own presence tuple. Information associated with the transaction can in certain aspects be used to determine an address of a presence server supporting the t-tuple and/or a presence tuple of a participant, a protocol, and/or authentication and authorization information used in establishing and using a subscription to status information.

For example, the transaction monitor component 206 can send a message to the presence service 310 that includes a command to add an identified participant to a subscription list of an identified t-tuple. Alternatively, the transaction monitor component 206 can send a message to the presence service 310 that hosts a presence tuple for an identified participant, where the message includes a command to add the presence tuple of the transaction to the participant's friends list.

Example 3 below depicts a friends list presence tuple of a participant that includes a t-tuple. When a participant logs in, subscriptions will automatically be made for all t-tuples in the friends list. In Example 3, the T-TUPLE elements are separated from the participant's configured friends by placing them in a T-TUPLE LIST element. Alternatively, t-tuple identifiers can be used in FRIEND ID elements so that no distinction is made with respect to the type of presence tuple in a friends list.

### EXAMPLE 3

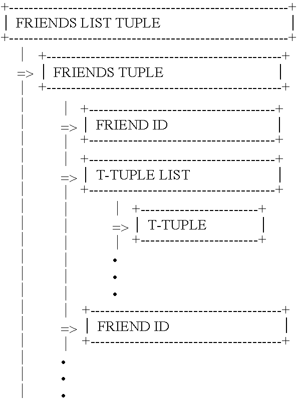

As described above, whenever the transaction handler component 204 and/or the transaction monitor component 206 detects a change in state of a transaction or a transition of a transaction to a state or life-cycle stage, the presentity 208 representing the transaction can be provided with the new state/stage information. The presentity 208 generates a message including a publish command that can include the new state/stage of the transaction in a tuple format compatible with the t-tuple 308 format of the presence service 310. The presentity 208 using a communication subsystem of the application server 204 transmits the message via the network 306 to the presence service 310 via the communication subsystem of the operating environment of the presence server 312. The presence service is configured to create and update the t-tuple 308 that corresponds to the presentity 208 that transmitted the message stored in a presence tuple database 314.

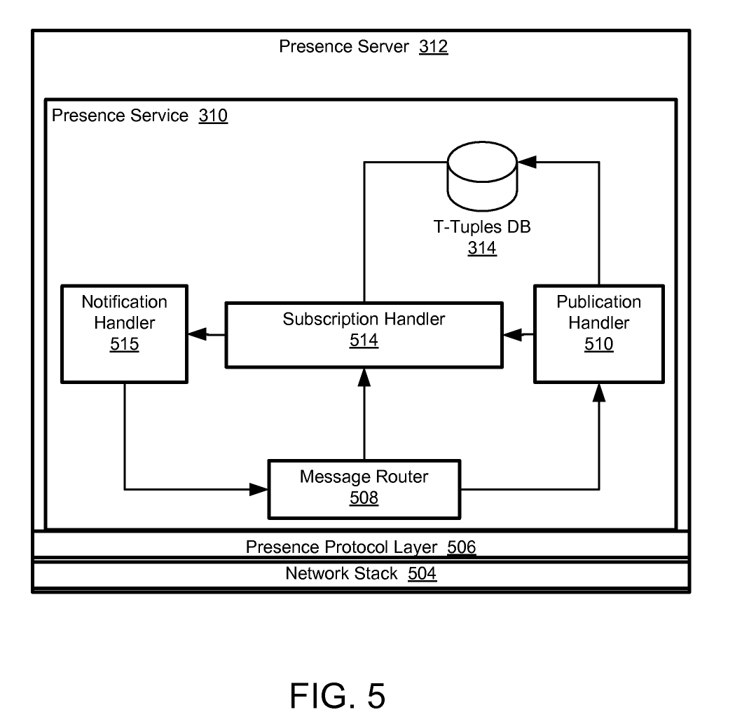

FIG. 5 is a block diagram illustrating a system for monitoring transaction status with a presence tuple according to another exemplary aspect of the subject matter described herein. The exemplary system illustrated includes the presence service 310 hosted by the presence server 312. The presence server 312 includes, for communication via the network 306, a network stack 504 and a presence protocol layer 506. Also shown is the t-tuples database 314 discussed in connection with FIG. 3, as well as a message router component 508, a publication handler component 510, a subscription handler component 514, and a notification handler component 515, each of which is described further below.

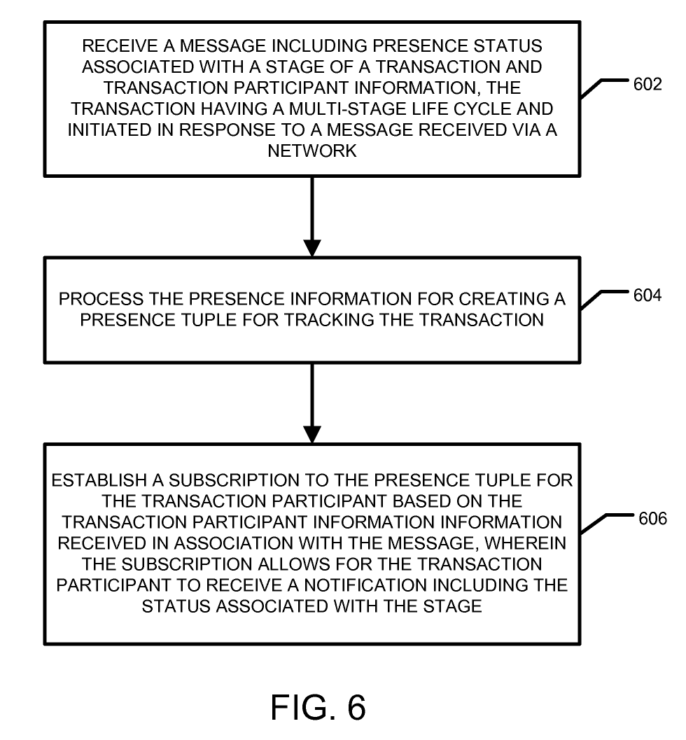

FIG. 6 is a flow diagram illustrating a method for monitoring transaction status with a presence tuple according to an exemplary aspect of the subject matter described herein. The method illustrated in FIG. 6 can be carried out by, for example, some or all of the components illustrated in the exemplary system of FIG. 5.

With reference to FIG. 6, in block 602, a message is received including presence status associated with a stage of a transaction and transaction participant information. The transaction has a multi-stage life-cycle and is initiated in response to a message received via a network. Accordingly, a system for monitoring transaction status with a presence tuple includes means for receiving a message including presence status associated with a stage of a transaction and transaction participant information, the transaction having a multi-stage life-cycle and initiated in response to a message received via a network. For example, as illustrated in FIG. 5, the message router component 508 is configured for receiving a message including presence status associated with a stage of a transaction and transaction participant information.

For example, the message router component 508 can receive a message including presence status associated with a life cycle stage of a transaction and transaction participant information via the presence protocol layer 506 interoperating with the network stack 504 where the network stack receives a representation of the message via a network such as the network 306 in FIG. 3. The presence status and participant information can be included in a single message and/or received in multiple messages separately.

In block 604, the presence information is processed for creating a presence tuple for tracking the transaction. Accordingly, a system for monitoring transaction status with a presence tuple includes means for processing the presence information for creating a presence tuple for tracking the transaction. For example, as illustrated in FIG. 5, the publication handler component 510 is configured for processing the presence information for creating a presence tuple for tracking the transaction.

For example, the publication handler 510 can receive the presence information from the message router 508. The message router 508 can be configured to route messages based on a detected message type. When presence information is received in a message including a publish command, the message router 508 can be configured to route presence information included in the message to the publication handler 510 for processing. The publication handler 510 can be configured to determine whether a presence tuple exists for a principal, such as a transaction, identified by the presence information. Presence tuples can be stored in a data store such as the T-Tuples database 314 discussed above. When the publication handler 510 determines that a tuple for the identified principal does exist, the publication handler 510 updates or provides for the creation of a tuple for storing the received presence information. When the publication handler 510 determines that a tuple does exist, the publication handler 510 updates or provides for the updating of the tuple based on the received presence information.

In block 606, a subscription to the presence tuple for the transaction participant is established based on the transaction participant information received in association with the message. The subscription allows for the transaction participant to receive a notification including the status associated with the stage. Accordingly, a system for monitoring transaction status with a presence tuple includes means for establishing a subscription to the presence tuple for the transaction participant based on the transaction participant information received in association with the message, wherein the subscription allows for the transaction participant to receive a notification including the status associated with the stage. For example, as illustrated in FIG. 5, the subscription handler component 514 is configured for establishing a subscription to the presence tuple for the transaction participant based on the transaction participant information received in association with the message

For example, the subscription handler 514, in an aspect, can detect the creation of a new t-tuple. Detection can occur through invocation of the subscription handler 514 by the publication handler 510 in response to the creation of a t-tuple and/or by the subscription handler 514 polling or receiving an event from the T-Tuples database 314. Based on participant information in the t-tuple, the subscription handler 514 can add a subscription for the participant to a subscriber list of the t-tuple. Alternately, the subscription handler 514 can add a friends list entry for the t-tuple to the participant's friends list when provided by an implementation.

Subscribed participants can receive notifications including a status update associated with a t-tuple via a watcher identified in the subscription information of the subscribed participant. For example, the notification handler component 515 in FIG. 5 can be configured for sending to the transaction participant a notification including the status associated with the stage pursuant to the established subscription to the presence tuple. Accordingly, participants subscribed to an updated t-tuple are sent notifications by the presence service 310 including the updated information.

With reference also to FIGS. 2 and 3, in another aspect, subscription information can be maintained by a subscription handler (not shown) of the transaction monitor component 206. In this aspect, it may not be necessary to establish a subscription to a t-tuple for a participant with the presence server 310. The transaction monitor component 206 can cause a presentity 208 corresponding to a transaction where a state/stage transition is detected to send a directed publish command in a message. That is, the message instructs the presence service 310 to generate a notification for participants/watchers identified in the message and can also include the status update for the t-tuple. The notification handler component 616 of the presence service 310 then sends a notification including the updated status/stage information to each identified participant/watcher, typically in response to an update to the t-tuple by the publication handler 510.

Using again the example of an online purchase, when a user places a new order, the transaction handler component 202 detects a transaction with a multi-stage life-cycle and identifies the transaction participant as the purchaser. The purchase transaction is initiated in response to a message received via the network, for example, via an HTTP POST command from the purchaser's browser 304. The transaction handler component 202 notifies the transaction monitor component 206. The transaction monitor component 206 provides a presentity 208 associated with the transaction for publishing the status of transaction to a t-tuple 308. The creation of the transaction in the example is a transition to the “new” life-cycle stage for the purchase transaction. The transaction monitor component 206 causes the presentity to send a message including an identifier of the t-tuple and the state/stage of the transaction. It should be appreciated; the transaction identifier and the t-tuple identifier may be combined into the same identifier. The presence server 310 receives the message via the network 306, and creates a new t-tuple 308 associated with the provided presentity 208.

The transaction monitor component 206, based on information determined from the transaction, such as an identifier of the sender of the message, an identity of a payment service, and/or the transaction processor's own identity, establishes a subscription to the t-tuple that can be maintained by the presence service 310, for example, or maintained by the transaction monitor component 206. The establishment of the subscription results in a notification message being generated and sent to the subscribed participant.

When subsequent stage transitions/state changes are detected, the transaction handler component 202 notifies the transaction monitor component 206 or the change is automatically detected by the transaction monitor component 206 by, for example, monitoring a transaction database record. The transaction monitor component 206 provides the updated status information to the corresponding presentity 208, which causes the presentity to publish the updated status to the corresponding t-tuple using a message sent via the network 306 to the presence service 310. The presence service 310 updates the t-tuple and sends a notification including the status information to a subscribed participant or as directed in the publish command.

Returning to the example depicted in the message flow diagram of FIG. 4, the transaction monitor component 206, based on information determined from the transaction, determines a participant that is to receive notifications of life-cycle stage transitions of the transaction. The transaction monitor component 206 sends an “AddSubscriber” message 412 including an identifier of the participant to the presentity 208 for processing. The presentity 208 generates a publish message 414 including information for causing the presence service 310 to establish a subscription for the identified user. For example, participant identification information can be used to determine a watcher associated with the participant to whom notifications including transaction status information are sent.

During, before, or subsequent to the providing of the presentity, the transaction handler component 202 processes a request. The processing is depicted as a message 406 that the transaction handler component 202 sends to itself typically in the form of a method or subroutine call. If a transition to another stage of the transaction life-cycle is detected, the transaction handler component 202 in the example sends an asynchronous message 416 to the transaction monitor component 206 identifying the transaction and the status associated with the transition to the stage. Other exemplary messaging that can be used includes support for a request/response message from the transaction handler component 202 to the transaction monitor component 206 or polling of the transaction handler component 202 by the transaction monitor component 206 for stage/status transitions. The transaction monitor component 206 in response to the new stage/status information sends an update message 420 to the presentity including an identifier of the t-tuple and the new stage/status. The presentity 208 sends a message 422 to the presence service to update the t-tuple status and send notifications to any subscriber or to indicate/update participants in the transactions.

The above description gives some examples of transactions that can be monitored and life-cycle stages associated with those transactions. One of ordinary skill in this art will recognize that many other transactions and associated life-cycle stages exist that the methods, systems, and computer program products can be used with. For example, real-time status can be tracked for various messages, such as email, voice mail, SMS, MMS. The messages can be tracked for transactions and life-cycle stages relating to sending, receiving, reading or hearing, tracking status of post-processing of the messages, and the like.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for monitoring transaction status with a presence tuple, the method comprising:
detecting a transaction having a multi-stage life-cycle and having a transaction participant, wherein the transaction is initiated in response to a message received via a network;
providing a presentity for tracking a status associated with a stage of the life-cycle and for publishing the status to a presence tuple associated with the presentity in response to the detection of a transition of the life-cycle to the stage; and
establishing a subscription to the presence tuple for the transaction participant based on information determined from the transaction, wherein the subscription allows for the transaction participant to receive a notification including the status associated with the stage.

2. The method of claim 1 wherein tracking a status associated with a stage of the life-cycle includes tracking a status associated with a stage corresponding to one of the transaction is new, the transaction is pending, and the transaction is complete.

3. The method of claim 1 wherein detecting a transaction having a participant includes detecting a transaction involving at least one of a consumer, a purchaser, a seller, an auditor, a processor, a registrar, a retailer, a shipper, a support provider, a payment service, and a security service.

4. The method of claim 1 wherein the transaction is associated with at least one of a process and a resource.

5. The method of claim 4 wherein the process includes at least one of a shopping cart process, a purchase, a payment authorization, a delivery process, a registration process, a login process, a messaging process, an upload process, a download process, a communication process, and a life-cycle of a data entity.

6. The method of claim 4 wherein the resource includes at least one of a data entity, a document, a file, a form, form-entered data, a communication, a session, a message, a request, and a response.

7. The method of claim 1 wherein the transition of the life-cycle to the stage is detected by at least one of monitoring a resource, detecting the receipt of a message, and detecting the sending of a message.

8. The method of claim 1 wherein establishing a subscription to the presence tuple for the transaction participant includes identifying a watcher for the transaction participant for sending notifications to the watcher including the status associated with the stage.

9. The method of claim 8 wherein the watcher is identified via one of an instant message identifier, an email address, a session initiation protocol (SIP) uniform resource locator (URL), an eXtensible messaging and presence protocol (XMPP) URL, and an identifier of a presence tuple of the transaction participant.

10. The method of claim 1 comprising sending to the transaction participant a notification including the status associated with the stage pursuant to the established subscription to the presence tuple.

11. A method for monitoring transaction status with a presence tuple, the method comprising:
receiving a message including presence status associated with a stage of a transaction and transaction participant information, the transaction having a multi-stage life-cycle and initiated in response to a message received via a network;
processing the presence information for creating a presence tuple for tracking the transaction; and
establishing a subscription to the presence tuple for the transaction participant based on the transaction participant information received in association with the message, wherein the subscription allows for the transaction participant to receive a notification including the status associated with the stage.

12. The method of claim 11 wherein establishing a subscription to the presence tuple for the transaction participant includes identifying a watcher for the transaction participant for sending notifications to the watcher including the status associated with the stage.

13. The method of claim 12 wherein the watcher is identified via one of an instant message identifier, an email address, a session initiation protocol (SIP) uniform resource locator (URL), an eXtensible messaging and presence protocol (XMPP) URL, and an identifier of a presence tuple of the transaction participant.

14. A system for monitoring transaction status with a presence tuple, the system comprising:
means for detecting a transaction having a multi-stage life-cycle and having a transaction participant, wherein the transaction is initiated in response to a message received via a network;
means for providing a presentity for tracking a status associated with a stage of the life-cycle and for publishing the status to a presence tuple associated with the presentity in response to the detection of a transition of the life-cycle to the stage; and
means for establishing a subscription to the presence tuple for the transaction participant based on information determined from the transaction, wherein the subscription allows for the transaction participant to receive a notification including the status associated with the stage.

15. A system for monitoring transaction status with a presence tuple, the system comprising:
a transaction handler component configured for detecting a transaction having a multi-stage life-cycle and having a transaction participant, wherein the transaction is initiated in response to a message received via a network; and
a transaction monitor component configured for providing a presentity for tracking a status associated with a stage of the life-cycle and for publishing the status to a presence tuple associated with the presentity in response to the detection of a transition of the life-cycle to the stage, the transaction monitor component also configured for establishing a subscription to the presence tuple for the transaction participant based on information determined from the transaction, wherein the subscription allows for the transaction participant to receive a notification including the status associated with the stage.

16. The system of claim 15 wherein the transaction monitor component is configured for providing a presentity for tracking a status associated with a stage corresponding to one of the transaction is new, the transaction is pending, and the transaction is complete.

17. The system of claim 15 wherein the transaction handler component is configured for detecting a transaction involving at least one of a consumer, a purchaser, a seller, an auditor, a processor, a registrar, a retailer, a shipper, a support provider, a payment service, and a security service.

18. The system of claim 15 wherein the transaction is associated with at least one of a process and a resource.

19. The system of claim 18 wherein the process includes at least one of a shopping cart process, a purchase, a payment authorization, a delivery process, a registration process, a login process, a messaging process, an upload process, a download process, a communication process, and a life-cycle of a data entity.

20. The system of claim 18 wherein the resource includes at least one of a data entity, a document, a file, a form, form-entered data, a communication, a session, a message, a request, and a response.

21. The system of claim 15 wherein the transaction handler component is configured for detecting the transition of the life-cycle to the stage by at least one of monitoring a resource, detecting the receipt of a message, and detecting the sending of a message.

22. The system of claim 15 wherein the transaction monitor component is configured for establishing a subscription to the presence tuple for the transaction participant by identifying a watcher for the transaction participant for sending notifications to the watcher including the status associated with the stage.

23. The system of claim 22 wherein the watcher is identified via one of an instant message identifier, an email address, a SIP URL, an XMPP URL, and an identifier of a presence tuple of the transaction participant.

24. The system of claim 15 comprising a notification handler configured for sending to the transaction participant a notification including the status associated with the stage pursuant to the established subscription to the presence tuple.

25. A system for monitoring transaction status with a presence tuple, the system comprising:
means for receiving a message including presence status associated with a stage of a transaction and transaction participant information, the transaction having a multi-stage life-cycle and initiated in response to a message received via a network;
means for processing the presence information for creating a presence tuple for tracking the transaction; and
means for establishing a subscription to the presence tuple for the transaction participant based on the transaction participant information received in association with the message, wherein the subscription allows for the transaction participant to receive a notification including the status associated with the stage.

26. A system for monitoring transaction status with a presence tuple, the system comprising:
a message router component configured for receiving a message including presence status associated with a stage of a transaction and transaction participant information, the transaction having a multi-stage life-cycle and initiated in response to a message received via a network;
a publication handler component configured for processing the presence information for creating a presence tuple for tracking the transaction; and
a subscription handler component configured for establishing a subscription to the presence tuple for the transaction participant based on the transaction participant information received in association with the message, wherein the subscription allows for the transaction participant to receive a notification including the status associated with the stage.

27. The system of claim 26 wherein the subscription handler component is configured for establishing a subscription to the presence tuple for the transaction participant by identifying a watcher for the transaction participant for sending notifications to the watcher including the status associated with the stage.

28. The system of claim 27 wherein the watcher is identified via one of an instant message identifier, an email address, a SIP URL, an XMPP URL, and an identifier of a presence tuple of the transaction participant.

29. A computer readable medium including a computer program, executable by a machine, for monitoring transaction status with a presence tuple, the computer program comprising executable instructions for:
detecting a transaction having a multi-stage life-cycle and having a transaction participant, wherein the transaction is initiated in response to a message received via a network;
providing a presentity for tracking a status associated with a stage of the life-cycle and for publishing the status to a presence tuple associated with the presentity in response to the detection of a transition of the life-cycle to the stage; and
establishing a subscription to the presence tuple for the transaction participant based on information determined from the transaction, wherein the subscription allows for the transaction participant to receive a notification including the status associated with the stage.

30. A computer readable medium including a computer program, executable by a machine, for monitoring transaction status with a presence tuple, the computer program comprising executable instructions for:
receiving a message including presence status associated with a stage of a transaction and transaction participant information, the transaction having a multi-stage life-cycle and initiated in response to a message received via a network;
processing the presence information for creating a presence tuple for tracking the transaction; and
establishing a subscription to the presence tuple for the transaction participant based on the transaction participant information received in association with the message, wherein the subscription allows for the transaction participant to receive a notification including the status associated with the stage.
